(19) United States
(12) Patent Application Publication
(10) Pub. No.: US 2025/0190240 A1
(43) Pub. Date: Jun. 12, 2025

(54) ADAPTIVE WAREHOUSES

(71) Applicant: Snowflake Inc., Bozeman, MT (US)

(72) Inventors: Prayag Chandran Nirmala, Seattle, WA (US); Samartha Chandrashekar, Bellevue, WA (US); Jason Polites, Mill Valley, CA (US); Jeffrey Rosen, San Mateo, CA (US); David Ruiz, San Francisco, CA (US); Michael Uhlar, Fox Island, WA (US); William Waddington, Stateline, NV (US); Shawn Zhang, Bozeman, MT (US)

(21) Appl. No.: 18/971,249

(22) Filed: Dec. 6, 2024

Related U.S. Application Data
(60) Provisional application No. 63/606,868, filed on Dec. 6, 2023.
(60) Provisional application No. 63/607,161, filed on Dec. 7, 2023.

(51) Int. Cl. G06F 9/455; G06F 16/28

(52) U.S. Cl. CPC G06F 9/45558; G06F 16/28; G06F 2009/4557

(57) ABSTRACT

Techniques for providing adaptive warehouses in a multi-tenant data system are described. The workloads for the account can be multiplexed in the adaptive warehouse environment. Warehouse endpoints in a warehouse layer can be defined for an account in the multi-tenant data system. A compute layer for the account can be divided into workload regions, where each workload region corresponds to a different workload type.

### CROSS-REFERENCE TO RELATED APPLICATIONS

This application claims the benefit of priority to U.S. Provisional Patent Application Ser. No. 63/606,868 filed Dec. 6, 2023, and to U.S. Provisional Patent Application Ser. No. 63/607,161 filed Dec. 7, 2023, the contents of which are incorporated herein by reference in their entireties.

### TECHNICAL FIELD

The present disclosure generally relates to data systems, and, more specifically, mechanisms for adaptive warehouse routing.

### BACKGROUND

As the world becomes more data driven, database systems and other data systems are storing more and more data. For a business to use this data, different operations or queries are typically run on this large amount of data. Some operations, for example those including large table scans or executing multiple queries, can take a substantial amount of time to execute on a large amount of data. Typically, the time to execute such operations can be proportional to the number of computing resources used for execution, so time can be shortened using more computing resources.

However, for certain operations, such as stored procedures, data systems may not be capable of using multiple computing resources in conjunction. These operations can slow the speed and efficiency of the data system.

### BRIEF DESCRIPTION OF THE DRAWINGS

Various ones of the appended drawings merely illustrate example embodiments of the present disclosure and should not be considered as limiting its scope.

FIG. 1 illustrates an example computing environment, according to some example embodiments.

FIG. 2 is a block diagram illustrating components of a compute service manager, according to some example embodiments.

FIG. 3 is a block diagram illustrating components of an execution platform, according to some example embodiments.

FIG. 4 is a simplified block diagram of a data system architecture for job scheduling in a data system, according to some example embodiments.

FIG. 5 is a simplified block diagram of an adaptive warehouse framework, according to some example embodiments.

FIG. 6 is a flow diagram for a method for routing workloads/jobs in an adaptive warehouse environment, according to some example embodiments.

FIG. 7 is a flow diagram for a method for executing a query using dynamic warehouse cluster sizing in a data system, according to some example embodiments.

FIG. 8 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Techniques for providing adaptive warehouses in a multi-tenant data system are described. The workloads for the account can be multiplexed in the adaptive warehouse environment. Warehouse endpoints in a warehouse layer can be defined for an account in the multi-tenant data system. A compute layer for the account can be divided into workload regions, where each workload region corresponds to a different workload type. Workloads/jobs from the warehouse endpoints can be routed to the different workload regions based on the workload types and different clusters in the respective workload region based on the workload sizes. Workloads can be collections of jobs that are submitted to respective warehouse endpoints. The multiplexing of the workloads leads to more efficient usage of computing resources assigned to the account and reduces underutilization of assigned computing resources. Moreover, a workload can be routed to one of a plurality of different sized clusters of different sizes based on the size of the workload to maximize performance.

Also, techniques for providing compute acceleration services for processing certain types of jobs in the multi-tenant data system are also described. For jobs, such as stored procedures and user defined functions (UDFs), the data system may employ a dedicated, separate set of computing resources in a compute-acceleration-service type workload region.

Moreover, techniques for a dynamic allocation to virtual warehouses in a multi-tenant data system are described. Users can provide inputs, such as a workload of queries, a service level objective (SLO) (i.e., desired completion time) for the workload, and cost budget. The data system can then dynamically adjust capacity allocation to virtual warehouses during the execution of the workload to meet the user inputs. Also, the data system can track the use of computing resources at the granularity of a warehouse endpoint.

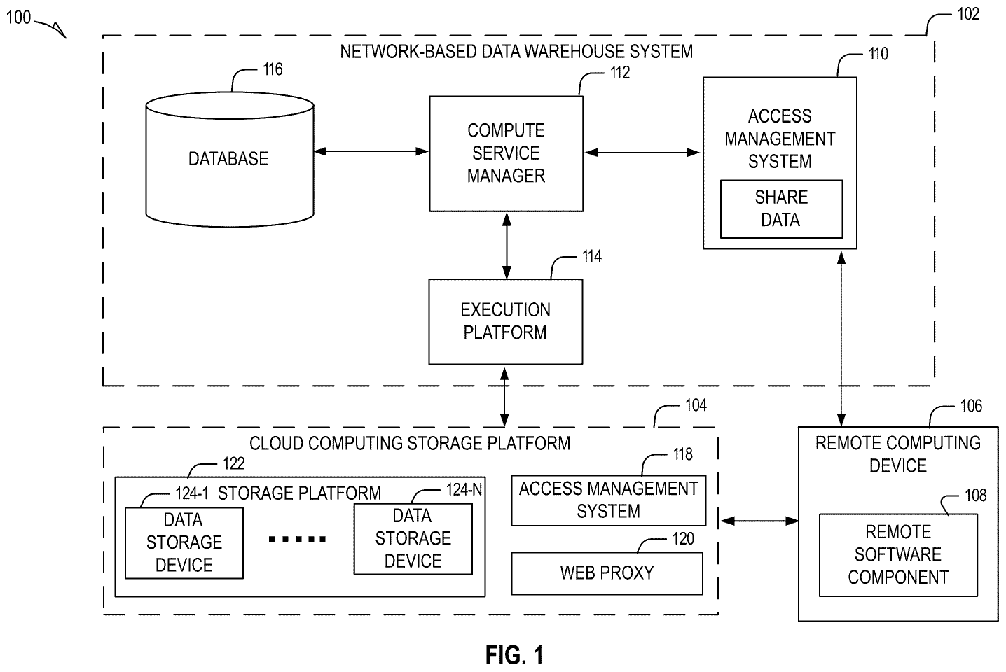

FIG. 1 illustrates an example shared data processing platform 100. To avoid obscuring the inventive subject matter with unnecessary detail, various functional components that are not germane to conveying an understanding of the inventive subject matter have been omitted from the figures. However, a skilled artisan will readily recognize that various additional functional components may be included as part of the shared data processing platform 100 to facilitate additional functionality that is not specifically described herein.

As shown, the shared data processing platform 100 comprises the network-based database system 102, a cloud computing storage platform 104 (e.g., a storage platform, an AWS® service, Microsoft Azure®, or Google Cloud Services®), and a remote computing device 106. The network-based database system 102 is a cloud database system used for storing and accessing data (e.g., internally storing data, accessing external remotely located data) in an integrated manner, and reporting and analysis of the integrated data from the one or more disparate sources (e.g., the cloud computing storage platform 104). The cloud computing storage platform 104 comprises a plurality of computing machines and provides on-demand computer system resources such as data storage and computing power to the network-based database system 102. While in the embodiment illustrated in FIG. 1, a data warehouse is depicted, other embodiments may include other types of databases or other data processing systems.

The remote computing device 106 (e.g., a user device such as a laptop computer) comprises one or more computing machines (e.g., a user device such as a laptop computer) that execute a remote software component 108 (e.g., browser accessed cloud service) to provide additional functionality to users of the network-based database system 102. The remote software component 108 comprises a set of machine-readable instructions (e.g., code) that, when executed by the remote computing device 106, cause the remote computing device 106 to provide certain functionality. The remote software component 108 may operate on input data and generates result data based on processing, analyzing, or otherwise transforming the input data. As an example, the remote software component 108 can be a data provider or data consumer that enables database tracking procedures, such as streams on shared tables and views, as discussed in further detail below.

The network-based database system 102 comprises an access management system 110, a compute service manager 112, an execution platform (also referred to as XP) 114, and a database 116. The access management system 110 enables administrative users to manage access to resources and services provided by the network-based database system 102. Administrative users can create and manage users, roles, and groups, and use permissions to allow or deny access to resources and services. The access management system 110 can store shared data that securely manages shared access to the storage resources of the cloud computing storage platform 104 amongst different users of the network-based database system 102, as discussed in further detail below.

The compute service manager 112 coordinates and manages operations of the network-based database system 102. The compute service manager 112 also performs query optimization and compilation as well as managing clusters of computing services that provide compute resources (e.g., virtual warehouses, virtual machines, EC2 clusters). The compute service manager 112 can support any number of client accounts such as end users providing data storage and retrieval requests, system administrators managing the systems and methods described herein, and other components/devices that interact with compute service manager 112.

The compute service manager 112 is also coupled to database 116, which is associated with the entirety of data stored on the shared data processing platform 100. The database 116 stores data pertaining to various functions and aspects associated with the network-based database system 102 and its users.

In some embodiments, database 116 includes a summary of data stored in remote data storage systems as well as data available from one or more local caches. Additionally, database 116 may include information regarding how data is organized in the remote data storage systems and the local caches. Database 116 allows systems and services to determine whether a piece of data needs to be accessed without loading or accessing the actual data from a storage device. The compute service manager 112 is further coupled to an execution platform 114, which provides multiple computing resources (e.g., virtual warehouses) that execute various data storage and data retrieval tasks, as discussed in greater detail below.

Execution platform 114 is coupled to multiple data storage devices 124-1 to 124-N that are part of a cloud computing storage platform 104. In some embodiments, data storage devices 124-1 to 124-N are cloud-based storage devices located in one or more geographic locations. For example, data storage devices 124-1 to 124-N may be part of a public cloud infrastructure or a private cloud infrastructure. Data storage devices 124-1 to 124-N may be hard disk drives (HDDs), solid state drives (SSDs), storage clusters, Amazon S3 storage systems or any other data storage technology. Additionally, cloud computing storage platform 104 may include distributed file systems (such as Hadoop Distributed File Systems (HDFS)), object storage systems, and the like.

The execution platform 114 comprises a plurality of compute nodes (e.g., virtual warehouses). A set of processes on a compute node executes a query plan compiled by the compute service manager 112. The set of processes can include: a first process to execute the query plan; a second process to monitor and delete micro-partition files using a least recently used (LRU) policy, and implement an out of memory (OOM) error mitigation process; a third process that extracts health information from process logs and status information to send back to the compute service manager 112; a fourth process to establish communication with the compute service manager 112 after a system boot; and a fifth process to handle all communication with a compute cluster for a given job provided by the compute service manager 112 and to communicate information back to the compute service manager 112 and other compute nodes of the execution platform 114.

The cloud computing storage platform 104 also comprises an access management system 118 and a web proxy 120. As with the access management system 110, the access management system 118 allows users to create and manage users, roles, and groups, and use permissions to allow or deny access to cloud services and resources. The access management system 110 of the network-based database system 102 and the access management system 118 of the cloud computing storage platform 104 can communicate and share information so as to enable access and management of resources and services shared by users of both the network-based database system 102 and the cloud computing storage platform 104. The web proxy 120 handles tasks involved in accepting and processing concurrent API calls, including traffic management, authorization and access control, monitoring, and API version management. The web proxy 120 provides HTTP proxy service for creating, publishing, maintaining, securing, and monitoring APIs (e.g., REST APIs).

In some embodiments, communication links between elements of the shared data processing platform 100 are implemented via one or more data communication networks. These data communication networks may utilize any communication protocol and any type of communication medium. In some embodiments, the data communication networks are a combination of two or more data communication networks (or sub-Networks) coupled to one another. In alternative embodiments, these communication links are implemented using any type of communication medium and any communication protocol.

As shown in FIG. 1, data storage devices 124-1 to 124-N are decoupled from the computing resources associated with the execution platform 114. That is, new virtual warehouses can be created and terminated in the execution platform 114 and additional data storage devices can be created and terminated on the cloud computing storage platform 104 in an independent manner. This architecture supports dynamic changes to the network-based database system 102 based on the changing data storage/retrieval needs as well as the changing needs of the users and systems accessing the shared data processing platform 100. The support of dynamic changes allows network-based database system 102 to scale quickly in response to changing demands on the systems and components within network-based database system 102. The decoupling of the computing resources from the data storage devices 124-1 to 124-N supports the storage of large amounts of data without requiring a corresponding large amount of computing resources. Similarly, this decoupling of resources supports a significant increase in the computing resources utilized at a particular time without requiring a corresponding increase in the available data storage resources. Additionally, the decoupling of resources enables different accounts to handle creating additional compute resources to process data shared by other users without affecting the other users' systems. For instance, a data provider may have three compute resources and share data with a data consumer, and the data consumer may generate new compute resources to execute queries against the shared data, where the new compute resources are managed by the data consumer and do not affect or interact with the compute resources of the data provider.

Compute service manager 112, database 116, execution platform 114, cloud computing storage platform 104, and remote computing device 106 are shown in FIG. 1 as individual components. However, each of compute service manager 112, database 116, execution platform 114, cloud computing storage platform 104, and remote computing environment may be implemented as a distributed system (e.g., distributed across multiple systems/platforms at multiple geographic locations) connected by APIs and access information (e.g., tokens, login data). Additionally, each of compute service manager 112, database 116, execution platform 114, and cloud computing storage platform 104 can be scaled up or down (independently of one another) depending on changes to the requests received and the changing needs of shared data processing platform 100. Thus, in the described embodiments, the network-based database system 102 is dynamic and supports regular changes to meet the current data processing needs.

During typical operation, the network-based database system 102 processes multiple jobs (e.g., queries) determined by the compute service manager 112. These jobs are scheduled and managed by the compute service manager 112 to determine when and how to execute the job. For example, the compute service manager 112 may divide the job into multiple discrete tasks and may determine what data is needed to execute each of the multiple discrete tasks. The compute service manager 112 may assign each of the multiple discrete tasks to one or more nodes of the execution platform 114 to process the task. The compute service manager 112 may determine what data is needed to process a task and further determine which nodes within the execution platform 114 are best suited to process the task. Some nodes may have already cached the data needed to process the task (due to the nodes having recently downloaded the data from the cloud computing storage platform 104 for a previous job) and, therefore, be a good candidate for processing the task. Metadata stored in the database 116 assists the compute service manager 112 in determining which nodes in the execution platform 114 have already cached at least a portion of the data needed to process the task. One or more nodes in the execution platform 114 process the task using data cached by the nodes and, if necessary, data retrieved from the cloud computing storage platform 104. It is desirable to retrieve as much data as possible from caches within the execution platform 114 because the retrieval speed is typically much faster than retrieving data from the cloud computing storage platform 104.

As shown in FIG. 1, the shared data processing platform 100 separates the execution platform 114 from the cloud computing storage platform 104. In this arrangement, the processing resources and cache resources in the execution platform 114 operate independently of the data storage devices 124-1 to 124-N in the cloud computing storage platform 104. Thus, the computing resources and cache resources are not restricted to specific data storage devices 124-1 to 124-N. Instead, all computing resources and all cache resources may retrieve data from, and store data to, any of the data storage resources in the cloud computing storage platform 104.

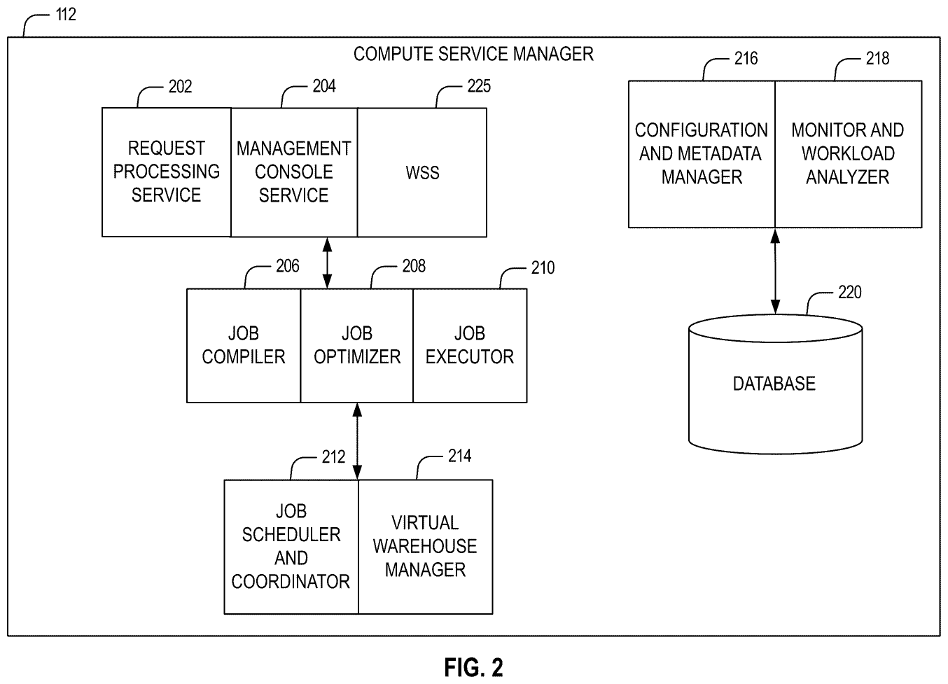

FIG. 2 is a block diagram illustrating components of the compute service manager 112, in accordance with some embodiments of the present disclosure. As shown in FIG. 2, a request processing service 202 manages received data storage requests and data retrieval requests (e.g., jobs to be performed on database data). For example, the request processing service 202 may determine the data necessary to process a received query (e.g., a data storage request or data retrieval request). The data may be stored in a cache within the execution platform 114 or in a data storage device in cloud computing storage platform 104. A management console service 204 supports access to various systems and processes by administrators and other system managers. Additionally, the management console service 204 may receive a request to execute a job and monitor the workload on the system.

The compute service manager 112 also includes a job compiler 206, a job optimizer 208, and a job executor 210. The job compiler 206 parses a job into multiple discrete tasks and generates the execution code for each of the multiple discrete tasks. The job optimizer 208 determines the best method to execute the multiple discrete tasks based on the data that needs to be processed. The job optimizer 208 also handles various data pruning operations and other data optimization techniques to improve the speed and efficiency of executing the job. The job executor 210 executes the execution code for jobs received from a queue or determined by the compute service manager 112.

A job scheduler and coordinator 212 sends received jobs to the appropriate services or systems for compilation, optimization, and dispatch to the execution platform 114. For example, jobs may be prioritized and processed in that prioritized order. In an embodiment, the job scheduler and coordinator 212 determines a priority for internal jobs that are scheduled by the compute service manager 112 with other “outside” jobs such as user queries that may be scheduled by other systems in the database but may utilize the same processing resources in the execution platform 114. In some embodiments, the job scheduler and coordinator 212 identifies or assigns particular nodes in the execution platform 114 to process particular tasks. A virtual warehouse manager 214 manages the operation of multiple virtual warehouses implemented in the execution platform 114. As discussed below, each virtual warehouse includes multiple execution nodes that each include a cache and a processor (e.g., a virtual machine, an operating system level container execution environment).

Additionally, the compute service manager 112 includes a configuration and metadata manager 216, which manages the information related to the data stored in the remote data storage devices and in the local caches (i.e., the caches in execution platform 114). The configuration and metadata manager 216 uses the metadata to determine which data micro-partitions need to be accessed to retrieve data for processing a particular task or job. A monitor and workload analyzer 218 oversees processes performed by the compute service manager 112 and manages the distribution of tasks (e.g., workload) across the virtual warehouses and execution nodes in the execution platform 114. The monitor and workload analyzer 218 also redistributes tasks, as needed, based on changing workloads throughout the network-based database system 102 and may further redistribute tasks based on a user (e.g., “external”) query workload that may also be processed by the execution platform 114. The configuration and metadata manager 216 and the monitor and workload analyzer 218 are coupled to a data storage device 220. Data storage device 220 in FIG. 2 represents any data storage device within the network-based database system 102. For example, data storage device 220 may represent caches in execution platform 114, storage devices in cloud computing storage platform 104, or any other storage device.

In some example embodiments, the compute service manager 112 may also include a Warehouse Scheduling Service (WSS) 225 as described in further detail below. The WSS 225 may manage the state of respective virtual warehouses, such as the size and configuration of virtual warehouses. The WSS 225 may manage adaptive warehouses for the account, as described in further detail below. The WSS 225 may communicate with a Server Management Service (SMS) to request allocation (or deallocations) of computing resources (e.g., execution platforms) for managing the adaptive warehouses.

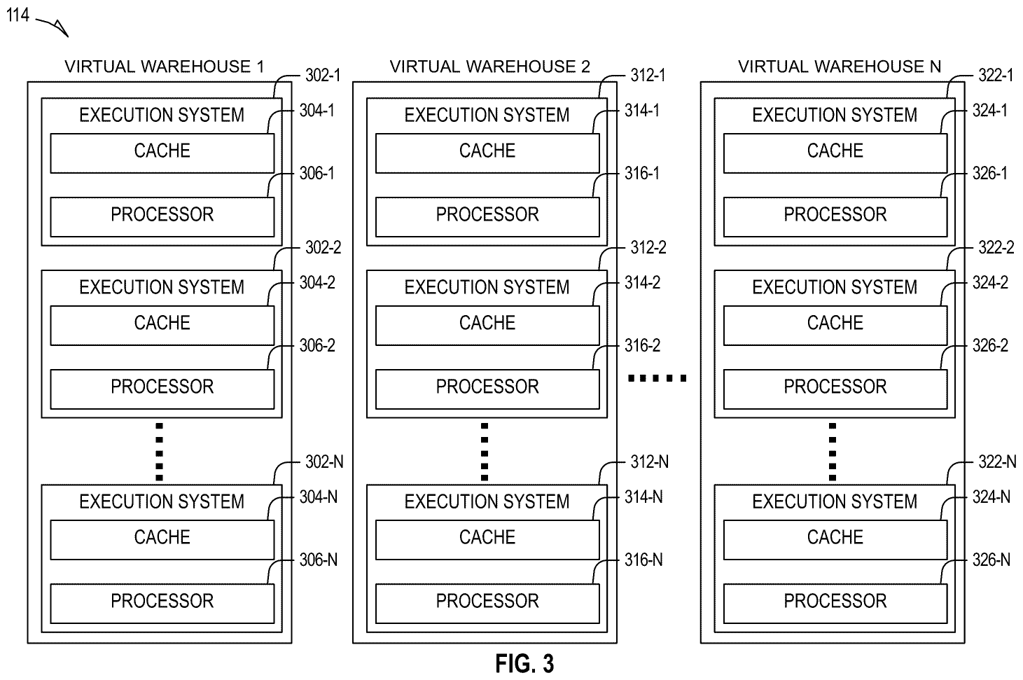

FIG. 3 is a block diagram illustrating components of the execution platform 114, in accordance with some embodiments of the present disclosure. As shown in FIG. 3, execution platform 114 includes multiple virtual warehouses, which are elastic clusters of compute instances, such as virtual machines. In the example illustrated, the virtual warehouses include virtual warehouse 1, virtual warehouse 2, and virtual warehouse n. Each virtual warehouse (e.g., EC2 cluster) includes multiple execution nodes (e.g., virtual machines) that each include a data cache and a processor. The virtual warehouses can execute multiple tasks in parallel by using the multiple execution nodes. As discussed herein, execution platform 114 can add new virtual warehouses and drop existing virtual warehouses in real time based on the current processing needs of the systems and users. This flexibility allows the execution platform 114 to quickly deploy large amounts of computing resources when needed without being forced to continue paying for those computing resources when they are no longer needed. All virtual warehouses can access data from any data storage device (e.g., any storage device in cloud computing storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary (e.g., upon a query or job completion).

Each virtual warehouse is capable of accessing any of the data storage devices 124-1 to 124-N shown in FIG. 1. Thus, the virtual warehouses are not necessarily assigned to a specific data storage device 124-1 to 124-N and, instead, can access data from any of the data storage devices 124-1 to 124-N within the cloud computing storage platform 104. Similarly, each of the execution nodes shown in FIG. 3 can access data from any of the data storage devices 124-1 to 124-N. For instance, the storage device 124-1 of a first user (e.g., provider account user) may be shared with a worker node in a virtual warehouse of another user (e.g., consumer account user), such that the other user can create a database (e.g., read-only database) and use the data in storage device 124-1 directly without needing to copy the data (e.g., copy it to a new disk managed by the consumer account user). In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data the execution nodes are caching. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each include one data cache and one processor, alternative embodiments may include execution nodes containing any number of processors and any number of caches. Additionally, the caches may vary in size among the different execution nodes. The caches shown in FIG. 3 store, in the local execution node (e.g., local disk), data that was retrieved from one or more data storage devices in cloud computing storage platform 104 (e.g., S3 objects recently accessed by the given node). In some example embodiments, the cache stores file headers and individual columns of files as a query downloads only columns necessary for that query.

To improve cache hits and avoid overlapping redundant data stored in the node caches, the job optimizer 208 assigns input file sets to the nodes using a consistent hashing scheme to hash over table file names of the data accessed (e.g., data in database 116 or database 122). Subsequent or concurrent queries accessing the same table file will therefore be performed on the same node, according to some example embodiments.

As discussed, the nodes and virtual warehouses may change dynamically in response to environmental conditions (e.g., disaster scenarios), hardware/software issues (e.g., malfunctions), or administrative changes (e.g., changing from a large cluster to smaller cluster to lower costs). In some example embodiments, when the set of nodes changes, no data is reshuffled immediately. Instead, the least recently used replacement policy is implemented to eventually replace the lost cache contents over multiple jobs. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud computing storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the execution platform 114 implements skew handling to distribute work amongst the cache resources and computing resources associated with a particular execution, where the distribution may be further based on the expected tasks to be performed by the execution nodes. For example, an execution node may be assigned more processing resources if the tasks performed by the execution node become more processor-intensive. Similarly, an execution node may be assigned more cache resources if the tasks performed by the execution node require a larger cache capacity. Further, some nodes may be executing much slower than others due to various issues (e.g., virtualization issues, network overhead). In some example embodiments, the imbalances are addressed at the scan level using a file stealing scheme. In particular, whenever a node process completes scanning its set of input files, it requests additional files from other nodes. If the one of the other nodes receives such a request, the node analyzes its own set (e.g., how many files are left in the input file set when the request is received), and then transfers ownership of one or more of the remaining files for the duration of the current job (e.g., query). The requesting node (e.g., the file stealing node) then receives the data (e.g., header data) and downloads the files from the cloud computing storage platform 104 (e.g., from data storage device 124-1), and does not download the files from the transferring node. In this way, lagging nodes can transfer files via file stealing in a way that does not worsen the load on the lagging nodes.

Although virtual warehouses 1, 2, and n are associated with the same execution platform 114, the virtual warehouses may be implemented using multiple computing systems at multiple geographic locations. For example, virtual warehouse 1 can be implemented by a computing system at a first geographic location, while virtual warehouses 2 and n are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and implements execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 114 is also fault tolerant. For example, if one virtual warehouse fails, that virtual warehouse is quickly replaced with a different virtual warehouse at a different geographic location.

A particular execution platform 114 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in cloud computing storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

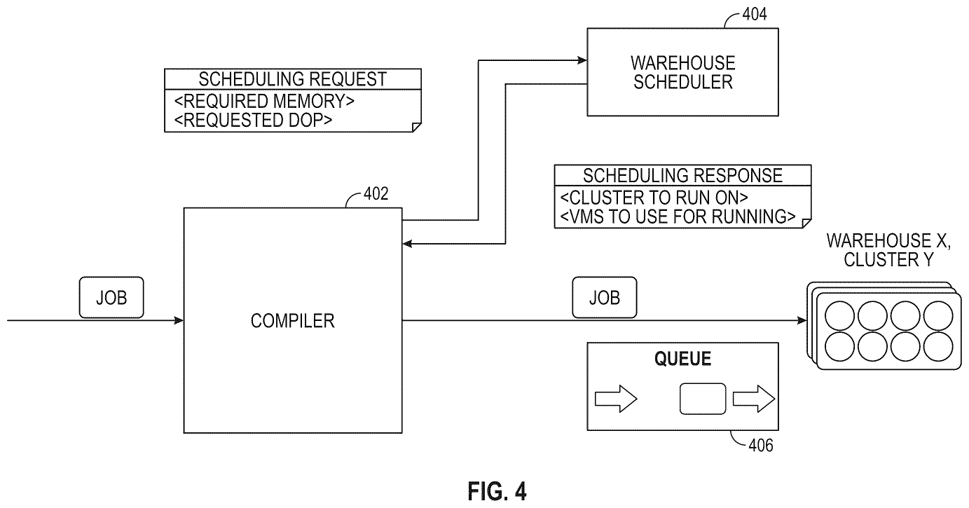

FIG. 4 is a simplified block diagram of a data system architecture for job scheduling in a data system, according to some example embodiments. As described above a user (e.g., computing device 106) transmits a job request (e.g., query) to a compiler 402 (e.g., job compiler 206, job optimizer 208 in compute service manager 112 described above). For example, the job request may be a SQL query. The compiler in the compute service manager may generate a job/query plan, where the query plan may include portions suitable for parallel computing (parallelable portions). The compiler 402 may generate a scheduling request for computing resources to execute the job or workload (collection of jobs). The scheduling request may include a memory component for the computing resources needed to execute the jobs and degree of parallelism (DOP). The scheduling request is transmitted to a warehouse scheduler 404. In some examples, the compiler 402 may transmit the DOP to the warehouse scheduler 404, where the DOP acts like the scheduling request. In some examples, warehouse scheduler 404 may be separate from the compute service manager.

In some other examples, the warehouse scheduler 404 may be provided as a component in the compute service manager. In some example embodiments, the compute service manager may also include a WSS (e.g., WSS 225), as described above. The WSS may manage the state of respective virtual warehouses, such as the size and configuration of virtual warehouses. The WSS may communicate with a SMS to request allocation (or deallocations) of computing resources (e.g., execution platforms), as described in further detail below.

The warehouse scheduler 404 (e.g., WSS) can organize a pool of cloud computing resources (e.g., execution platforms 114) to form virtual warehouses, as described above. The virtual warehouses include execution systems with processors and local memories, as described above. The warehouse scheduler 404 can allocate a number of computing resources in a specified virtual warehouse in response to the scheduling request. The warehouse scheduler 404 can transmit the allocation as a scheduling response, which can specify which warehouse and cluster (group of VMs within warehouse) are to be used to process the workload or job. For example, the scheduling response 404 may include the cluster to run on and VMs to use for running.

The compiler 402 may also place the pending job in a queue 406 for the specified warehouse (warehouse x, cluster y). In some examples, the queue 406 may be a first-in-first-out type queue. In some examples, some jobs may be prioritized over other jobs based on types of jobs, service level object (SLO), user, etc. When the pending job reaches the top of queue 406, the job is scheduled to be executed by the specified warehouse (and cluster) based on the scheduling response.

This job execution process can encounter issues with some type of operations, such as stored procedures, user defined functions (UDF), that cannot take advantage of multiple computing resources working in parallel in a warehouse. Stored procedures typically include logic to perform database operations by executing statements. Stored procedures can allow for dynamic creation and execution of statements (e.g., SQL statements). Stored procedures can allow execution of the code with privileges of the role that owns the procedure, rather than with the privileges of the role that runs the procedure. This allows the stored procedure owner to delegate the power to perform specified operations to users who otherwise could not do so themselves. In some examples, stored procedures can automate functions that require multiple statements.

Stored procedures can be in different programming languages. For example, stored procedures can be written in a different language than the programming language used by the data system. For example, the stored procedure can be provided in Java, JavaScript, Python, Scala, etc. Notably, stored procedures cannot be broken down in parallel portions (e.g., tasks) to be executed using a plurality of computing resources (VMs) in parallel. Thus, when a warehouse executes a stored procedure, the warehouse the stored procedure using a single VM, leaving the other VMs in the warehouse underutilized.

Like stored procedures, UDFs are also typically executed by a single VM rather than a group of VMs in parallel. The UDF may be provided in a different programming language (e.g., java, python) than what is used in the data system. The UDF therefore may be treated as untrusted code by the data system and the UDF may be executed in a sandbox. When a warehouse executes a UDF, the warehouse executes the UDF using a single VM, leaving the other VMs in the warehouse underutilized.

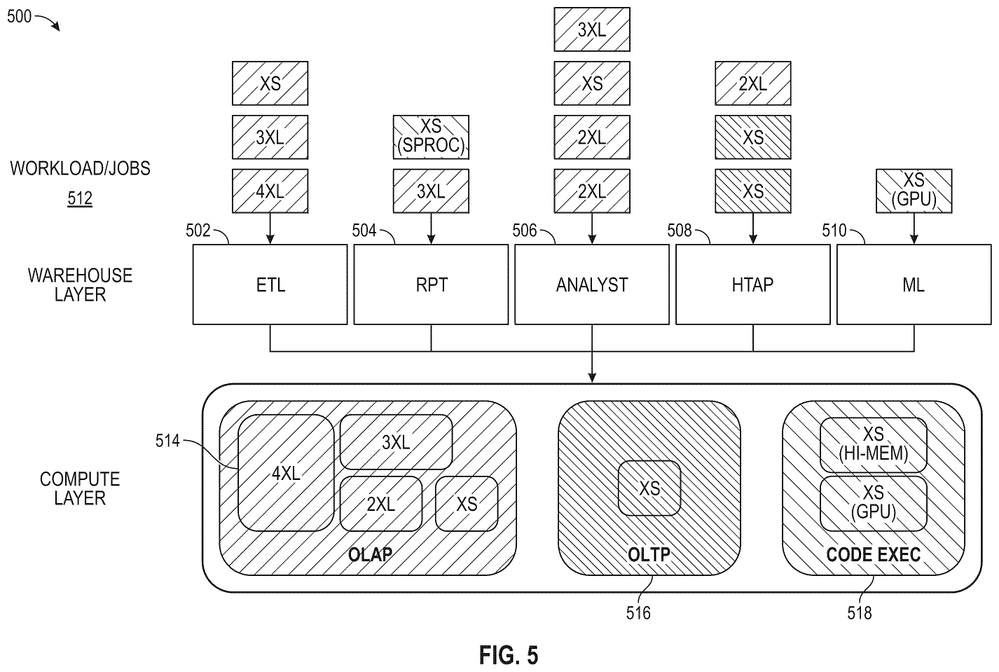

FIG. 5 is a simplified block diagram of an adaptive warehouse framework 500, according to some example embodiments. The adaptive warehouse framework 500 is account specific; that is, the adaptive warehouse framework 500 is provided for a single account. Each account in the data system may have its own corresponding adaptive warehouse framework 500. In some examples, an account may have multiple adaptive warehouse frameworks. For example, an account may have one framework for development and testing and another framework for production traffic.

The adaptive warehouse framework 500 includes a warehouse layer with a plurality of warehouse endpoints 502-510. Each endpoint 502-510 may correspond to a different user-defined operation. For example, endpoint 502 may correspond to extract, transform, and load (ETL) operations. Endpoint 504 may correspond to reporting (RPT) operations. Endpoint 506 may correspond to analyst operations. Endpoint 508 may correspond to hybrid transactional/analytical processing (HTAP) operations. Endpoint 510 may correspond to machine learning (ML) operations. The endpoints may be defined by a user of the account. Workloads/jobs 512 for the account may be inputted into the endpoints 502-510. As described below, usage reports (including costs) may be produced for each

A compute layer is provided beneath the warehouse layer and manages compute resources for virtual warehouses defined within an account. As described in further detail below, compute resources can be organized in clusters and can be managed by the compute layer may vary in size and instance type. Cluster operations, such as spin up, spin down, resize, concurrency, etc., are managed by the compute layer.

The compute layer may include different workload regions 514-518 (also referred to as workload pools), where each workload region includes a set of compute resources (see FIG. 3) organized in clusters reserved exclusively for a specific workload type. Workload regions (or workload pools) may provide custom scheduling optimizations for the respective workload type. For example, SQL queries and stored procedures can be optimized to support different levels of bin packing, retry logic or run on different instance types. In this example, workload region 514 corresponds to an online analytical processing (OLAP) region. OLAP jobs may include queries, SQL statements, ETL, and other similar operations.

Workload region 516 may correspond to an online transactional processing (OLTP) region 518. OTLP jobs may include small, light-weight transactional workloads, such as point-fetch type queries (e.g., looking up a particular customer based on customer ID). For OLTP jobs, region 518 may be optimized or aggressive spinup help reduce/eliminate queueing.

Workload region 518 may correspond to a code execution (code exec) region. Code execution region may also be referred to as compute acceleration service region. Code execution jobs may include UDFs, stored procedures, and more complicated operations, such as operations written in a different programming language such as java or python. Code execution jobs may include jobs where operations, such as stored procedure and UDFS, are executed by a single VM.

Each workload region may be configured with custom policies tailored to support the workload type. For example, the OLTP region may include a hyper aggressive cluster spin up policy to avoid queuing jobs (e.g., HTAP type jobs).

Workloads/jobs 512 are submitted to the compute layer via a warehouse endpoint. The warehouse endpoints 502-510 may receive jobs of different sizes (e.g., XS, M, L, XL, etc.) and correspond to different workload regions 514-518. In this example, warehouse endpoint 502 (ETL) receives XS, 3XL, and 4XL jobs, all for warehouse region 514 (OLAP). Warehouse endpoint 504 (RPT) receives a 3XL job for warehouse region 514 (OLAP) and a XS job warehouse region 518 (code exec). Warehouse endpoint 506 (Analyst) receives 2XL, 2XL, XS, and 3XL jobs, all for warehouse region 514 (OLAP). Warehouse endpoint 508 (HTAP) may receive two XS jobs for warehouse region 516 (OLTP) and a 2XL job for warehouse region 514 (OLAP). Warehouse endpoint 510 (ML) receives a XS job for warehouse region 518 (code exec).

The warehouse endpoints submit the jobs to the compute layer, and the compute layer routes the jobs to the appropriate warehouse region and cluster size for execution. For example, OLAP jobs are routed to clusters provisioned in warehouse region 514 (OLAP). OLTP jobs are routed to clusters provisioned in warehouse region 516 (OLTP). Code execution jobs are routed to clusters provisioned in warehouse region 518 (code exec). The compute layer is configured to schedule the jobs on existing clusters. In some examples, if no cluster of the specified size is provisioned, the compute layer may spin up a new cluster of the appropriate size. The compute layer is configured to maximize compute resource utilization across the account.

For example, jobs, such as stored procedures, UDFs, and the like may be routed to the code execution region, which is specifically tailored to handle more complex operations, such as non-SQL compute intensive operations. In some examples, the code execution region may be isolated from other virtual warehouses for security purposes. For example, a virtual warehouse for the account may be provided in a first virtual private cloud (VPC_1) while the compute acceleration service may be provided in a second virtual private cloud (VPC_2).

To handle UDFs and some stored procedures, the VM code execution region may execute the UDF or stored procedure in a sandbox environment. In computer security, a sandbox (e.g., sandbox environment) is a security mechanism for separating running programs, usually to prevent system failures or prevent exploitation of software vulnerabilities. A sandbox can be used to execute untested or untrusted programs or code, possibly from unverified or untrusted third parties, suppliers, users or websites, without risking harm to the host machine or operating system. A sandbox can provide a tightly controlled set of resources for guest programs to run in, such as storage and memory scratch space. Network access, the ability to inspect the host system or read from input devices can be disallowed or restricted. UDFs typically can run in a sandbox environment.

A sandbox process, in an example, is a program that reduces the risk of security breaches by restricting the running environment of untrusted applications using security mechanisms such as namespaces and secure computing modes (e.g., using a system call filter to an executing process and all its descendants, thus reducing the attack surface of the kernel of a given operating system). Moreover, in an example, the sandbox process is a lightweight process in comparison to an execution node process and is optimized (e.g., closely coupled to security mechanisms of a given operating system kernel) to process a database query in a secure manner within the sandbox environment. In some embodiments, the UDF is executed using the UDF server, which is restricted from accessing certain files and file systems. For example, the UDF server and a worker process handling other operations for the continuous auto-ingestion may be provided as different processors on the same machine.

In some embodiments, the sandbox process can utilize a virtual network connection in order to communicate with other components within the subject system. A specific set of rules can be configured for the virtual network connection with respect to other components of the subject system. For example, such rules for the virtual network connection can be configured for a particular UDF to restrict the locations (e.g., particular sites on the Internet or components that the UDF can communicate) that are accessible by operations performed by the UDF. Thus, in this example, the UDF can be denied access to particular network locations or sites on the Internet.

The sandbox process can be understood as providing a constrained computing environment for a process (or processes) within the sandbox, where these constrained processes can be controlled and restricted to limit access to certain computing resources.

Examples of security mechanisms can include the implementation of namespaces in which each respective group of processes executing within the sandbox environment has access to respective computing resources (e.g., process IDs, hostnames, user IDs, file names, names associated with network access, and inter-process communication) that are not accessible to another group of processes (which may have access to a different group of resources not accessible by the former group of processes), other container implementations, and the like. By having the sandbox process execute as a sub-process to the execution node process, in some embodiments, latency in processing a given database query can be substantially reduced (e.g., a reduction in latency by a factor of 10× in some instances) in comparison with other techniques that may utilize a virtual machine solution by itself.

The sandbox process can utilize a sandbox policy to enforce a given security policy. The sandbox policy can be a file with information related to a configuration of the sandbox process and details regarding restrictions, if any, and permissions for accessing and utilizing system resources. Example restrictions can include restrictions to network access, or file system access (e.g., remapping file system to place files in different locations that may not be accessible, other files can be mounted in different locations, and the like). The sandbox process restricts the memory and processor (e.g., CPU) usage of the user code runtime, ensuring that other operations on the same execution node can execute without running out of resources.

As mentioned above, the sandbox process is a sub-process (or separate process) from the execution node process, which in practice means that the sandbox process resides in a separate memory space than the execution node process. In an occurrence of a security breach in connection with the sandbox process (e.g., by errant or malicious code from a given UDF), if arbitrary memory is accessed by a malicious actor, the data or information stored by the execution node process is protected.

The code execution region can include a pool of VMs with different processing capabilities to handle different types of stored procedures, UDFs, etc., such as those including machine-learning components. For example, the compute services can include standard machines (with standard CPU and memory capabilities), higher-memory machines, and graphic processing units (GPU). The scheduler may then assign stored procedures, UDFs, etc., to VMs with the appropriate processing capabilities.

In some examples, the stored procedures, UDFs, etc., may indicate what processing capabilities are needed for execution. An example portion of a stored procedure can include:
create or replace procedure myProc(count INT)
returns string
language java
runtime_version=‘11’
resources=(CPU CORES=2, MEMORY=16 GB, GPU=2)
packages=(‘park:latest’)

The “resources” section may indicate to the scheduler what type of resources are needed to execute the stored procedure. The resources section may also include information about the CPU architecture in some examples.

In some examples, the data system can infer the processing capabilities needed to execute the stored procedure, UDF, etc. For example, if the stored procedure includes a call to a Compute Unified Device Architecture (CUDA) library, the scheduler may infer that a GPU is needed for the stored procedure.

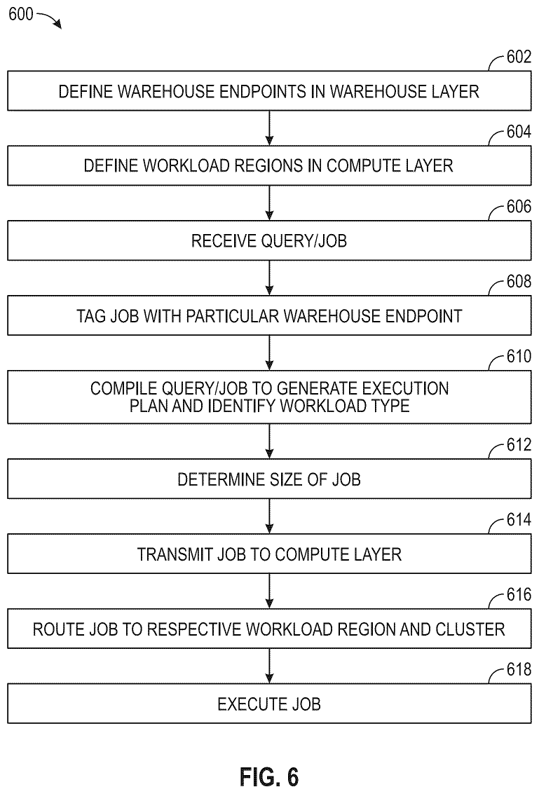

FIG. 6 is a flow diagram for a method 600 for routing workloads/jobs in an adaptive warehouse environment, according to some example embodiments. At operation 602, warehouse endpoints in a warehouse layer are defined. The warehouse endpoints may correspond to different user-defined operations (e.g., ETL, RPT, HTAP, Analyst, HTAP). The warehouse endpoints may be considered a warehouse object (or dictionary object) for generating a façade layer for organizing the different workload/jobs. The warehouse endpoints may be used for tracking different types of business processes. For example, budget, cost, resource usage, and other similar metrics can be tracked per warehouse endpoint. The warehouse endpoints may have different configurations. The configurations may include different tracking metrics.

In some examples, a user of an account can create a warehouse endpoint by using a create command. The user can name the warehouse endpoint (e.g., Analyst). In some examples, prior warehouses may be migrated into a warehouse endpoint. For example, an alter statement may be used to migrate a prior warehouse to a particular warehouse endpoint.

At operation 604, different workload regions in a compute layer are defined. Each workload region may include a set of compute resources (see FIG. 3) organized in clusters reserved exclusively for a specific workload type. As discussed below, jobs from the different endpoints may be routed to different warehouse regions based on workload type. Jobs from endpoints (n) may be routed to any of the warehouse regions (m) based on workload type, making a n to m (many to many) type of adaptive warehouse environment.

At operation 606, a query is received from the account. At operation 608, the query (or job) is tagged to a particular warehouse endpoint (e.g., (e.g., ETL, RPT, HTAP, Analyst, HTAP). At operation 610, the compiler may compile the query and generate an execution plan. The compiler may also identify the workload type of the query (workload/job).

The execution plan may be optimized based on optimization rules. The rules may be directed to pruning or constant folding one or more operators based on predicate properties, predicate simplification, filter pushdown, eliminating unnecessary grouping or aggregation, and/or other suitable rules.

At operation 612, the size of the workload/job is determined. For example, a degree of parallelism (DOP) of the workload/job may be determined. The size of the workload/job may be determined based on the DOP (e.g., XS, S, M, L, XL, etc.). The size of the workload/job may be determined based on the optimized execution plan.

At operation 614, the workload/job is sent to the compute layer. At operation 616, the compute layer routes the workload/job to a respective workload region (e.g., OLAP, OLTP, code exec, etc.) based on the identified workload type of the work/load job. The compute layer also routes the workload/job to a particular cluster in the workload region based on the identified size of the workload/type. For example, a 2XL job may be routed to a 2XL size cluster in the respective workload region. If there is no cluster of the identified size in the workload region, the compute layer may spin up a new cluster of the specified size.

In some examples, the compute layer may modify the decision of the compiler on the size of the warehouse to be used for the workload. For example, the compute layer may determine that the identified cluster size in the specified warehouse region is unavailable, and it would be cost prohibitive to spin up a new cluster of that size. In that situation, the compute layer may schedule the workload at different size cluster than the identified workload size. For example, a compiler may determine a job is a 2XL size job, but the compute layer may determine that spinning up a 2XL cluster is cost prohibitive; therefore, the compute layer may route the job to a 3XL cluster in the workload region.

At operation 618, the workload/job is executed by the respective cluster in the workload region. Hence, different workloads for an account can be multiplexed together in an adaptive warehouse environment. The multiplexing of the workloads leads to more efficient usage of computing resources assigned to the account and reduces underutilization of assigned computing resources.

In some examples, the warehouse scheduler may also monitor the execution of the workload/job and dynamically change the number of VMs in the allocated cluster/warehouse based on the progress of the job execution and the capacity inputs provided by the user. As mentioned above, a warehouse is defined per-account. For example, a warehouse may only belong to one account, but one account may include multiple warehouse endpoints.

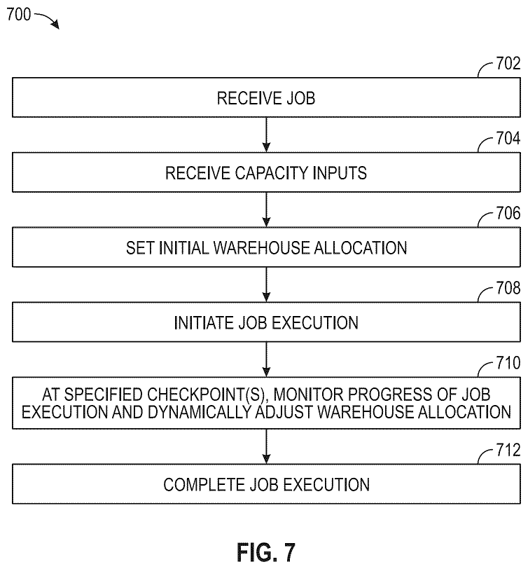

FIG. 7 is a flow diagram for a method 700 for executing a query using dynamic warehouse cluster sizing in a data system, according to some example embodiments. At operation 702, a job/query is received. For example, a compute service manager may receive the job/query from a user. The compiler in the compute service manager may generate a job/query plan, where the query plan may include portions suitable for parallel computing (parallelable portions).

At operation 704, capacity inputs are received. For example, a service level objective (SLO) (i.e., desired completion time) and cost budget for the job may be received from the user. In some examples, the data system may offer different choices for performance quality (e.g., low, medium, high). SLO and cost budgets may be determined by the data system from the selection of the performance quality.

At operation 706, a warehouse scheduler (e.g., WSS), as described above, in the data system sets an initial allocation of VMs for a warehouse to execute the job/workload based on the resource needs for the parallelizable portions and the capacity inputs (e.g., SLO and cost budget. In some examples, the initial allocation can be a default value (e.g., two small VMs). The initial allocation may be communicated to the compute service manager, which may route the job/query to the initial allocation of VMs of the warehouse. A queue may be used as described above.

At operation 708, execution of the job using the initial warehouse size is initiated.

At operation 710, at specified checkpoints, the progress of the job execution is monitored, and the warehouse size is dynamically adjusted based on the progress and capacity inputs. For example, a linear progression of the job execution may be determined at respective checkpoints to determine if the allocated warehouse size can meet SLO and cost budget.

For example, a first checkpoint may be set at a quarter of the SLO (completion time), and from the beginning of execution and the first checkpoint, the progress of the execution is observed. At the first checkpoint, the warehouse scheduler may observe the progress of the job execution and may change the number of VMs in the warehouse based on the capacity input. A linear progression of the job execution may be determined. For example, if the job execution is proceeding faster than expected and the initial warehouse size was five VMs, the warehouse scheduler can reduce the allocation to three VMs in the warehouse. The two VMs which have been de-allocated may be released back to the pool of VMs and can be reallocated by the warehouse scheduler.

A second checkpoint may be set at the halfway point. The warehouse scheduler may again monitor the performance of the job execution and adjust the warehouse size based on the progress and capacity input. In some examples, the warehouse scheduler, at the halfway checkpoint (or other specified checkpoints), may determine whether the job can be executed at the SLO based on the cost budget. If the job cannot be executed within the SLO at the requested cost budget, the data system may flag this issue to the user. For example, the data system may transmit a message to the user or list the message in a history view.

In the example above, the modified allocation of three VMs may be increased to six VMs if the scheduler determines that more VMs are needed to meet the SLO. Therefore, three additional VMs from the pool may be added to the warehouse.

In some examples, the VMs may already be “running” in the pool so that addition to the warehouse results in near instantaneous use. Typically, a VM can take 20-30 seconds to begin running so maintaining a pool of running VMs can offer improved efficiency. The VMs may be running a software stack of the data system without any job executions so that when added to the warehouse, they can quickly start contributing to the job execution. Also, the pool of running VMs should be optimally sized.

At operation 712, the job execution may be completed. In some examples, a report may be generated indicating the number of VMs used and for how long. Hence, a customer of the data system can be charged per query/job instead of block time charges.

In addition to the size of warehouses, the type of VMs in the warehouse can be dynamically changed. For example, VMs with different CPU speeds and/or memories may be used.

Queuing information can be used to adjust the size of the clusters. Queuing information can determine whether to increase or decrease size of individual clusters rather than merely adding or removing clusters. As an initial matter, the data system can increase or decrease the size of individual clusters in a warehouse based on the size of the queue. If the queue load does not change after changing the size of individual clusters, then the data system can then add or remove clusters.

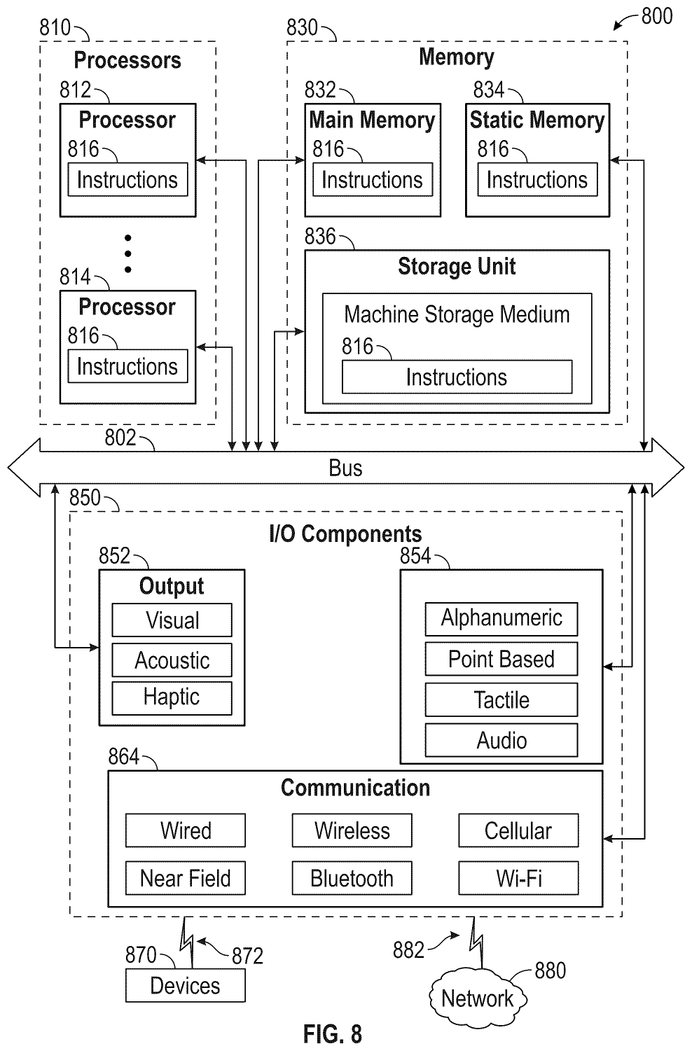

FIG. 8 illustrates a diagrammatic representation of a machine 800 in the form of a computer system within which a set of instructions may be executed for causing the machine 800 to perform any one or more of the methodologies discussed herein, according to an example embodiment. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example, the instructions 816 may cause the machine 800 to execute any one or more operations of any one or more of the methods described herein. As another example, the instructions 816 may cause the machine 800 to implement portions of the data flows described herein. In this way, the instructions 816 transform a general, non-programmed machine into a particular machine 800 (e.g., the remote computing device 106, the access management system 110, the compute service manager 112, the execution platform 114, the access management system 118, the Web proxy 120) that is specially configured to carry out any one of the described and illustrated functions in the manner described herein.

In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 includes processors 810, memory 830, and input/output (I/O) components 850 configured to communicate with each other such as via a bus 802. In an example embodiment, the processors 810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 816. The term “processor” is intended to include multi-core processors 810 that may comprise two or more independent processors (sometimes referred to as “cores”) that may execute instructions 816 contemporaneously. Although FIG. 8 shows multiple processors 810, the machine 800 may include a single processor with a single core, a single processor with multiple cores (e.g., a multi-core processor), multiple processors with a single core, multiple processors with multiple cores, or any combination thereof.

The memory 830 may include a main memory 832, a static memory 834, and a storage unit 836, all accessible to the processors 810 such as via the bus 802. The main memory 832, the static memory 834, and the storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 include components to receive input, provide output, produce output, transmit information, exchange information, capture measurements, and so on. The specific I/O components 850 that are included in a particular machine 800 will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, and other communication components to provide communication via other modalities. The devices 870 may be another machine or any of a wide variety of peripheral devices (e.g., a peripheral device coupled via a universal serial bus (USB)). For example, as noted above, the machine 800 may correspond to any one of the remote computing device 106, the access management system 118, the compute service manager 112, the execution platform 114, the Web proxy 120, and the devices 870 may include any other of these systems and devices.

The various memories (e.g., 830, 832, 834, and/or memory of the processor(s) 810 and/or the storage unit 836) may store one or more sets of instructions 816 and data structures (e.g., software) embodying or utilized by any one or more of the methodologies or functions described herein. These instructions 816, when executed by the processor(s) 810, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 880 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., hypertext transfer protocol (HTTP)). Similarly, the instructions 816 may be transmitted or received using a transmission medium via the coupling 872 (e.g., a peer-to-peer coupling) to the devices 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 816 for execution by the machine 800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Described implementations of the subject matter can include one or more features, alone or in combination as illustrated below by way of example.

Example 1. A method comprising: providing a plurality of warehouse endpoints in a network-based data warehouse system, each endpoint representing a different user-defined operation; providing a plurality of workload regions in a compute layer, each workload region representing a workload type, each workload region including one or more clusters of virtual warehouses, and each endpoint being connected to each workload region; receiving a workload; routing the workload through a first warehouse endpoint of the plurality of warehouse endpoints to a first workload region of the plurality of workload regions; and executing the workload by virtual machines in the first workload region.

Example 2. The method of example 1, further comprising: identifying a type of the workload, wherein the workload is routed to the first workload region based on the type of the workload.

Example 3. The method of any of examples 1-2, further comprising: determining a size of the workload, wherein the workload is routed to a first cluster of the one or more clusters in the first workload region based on the size of the workload.

Example 4. The method of any of examples 1-3, wherein the size is based on a degree of parallelism of the workload.

Example 5. The method of any of examples 1-4, wherein the workload includes a query.

Example 6. The method of any of examples 1-5, further comprising: compiling the query to generate an execution plan.

Example 7. The method of any of examples 1-6, further comprising: optimizing the execution plan based on a set of optimization rules; and determining a size of the workload based on the optimized execution plan.

Example 8. The method of any of examples 1-7, further comprising: monitoring execution of the workload at a checkpoint; and adjusting allocation of the virtual machines based on the monitoring.

Example 9. A system comprising: one or more processors of a machine; and a memory storing instructions that, when executed by the one or more processors, cause the machine to perform operations implementing any one of example methods 1 to 8.

Example 10. A machine-readable storage device embodying instructions that, when executed by a machine, cause the machine to perform operations implementing any one of example methods 1 to 8.

What is claimed is:

1. A method comprising:
providing a plurality of warehouse endpoints in a network-based data warehouse system, each endpoint representing a different user-defined operation;
providing a plurality of workload regions in a compute layer, each workload region representing a workload type, each workload region including one or more clusters of virtual warehouses, and each endpoint being connected to each workload region;
receiving a workload;
routing the workload through a first warehouse endpoint of the plurality of warehouse endpoints to a first workload region of the plurality of workload regions; and
executing the workload by virtual machines in the first workload region.

2. The method of claim 1, further comprising:
identifying a type of the workload, wherein the workload is routed to the first workload region based on the type of the workload.

3. The method of claim 1, further comprising:
determining a size of the workload, wherein the workload is routed to a first cluster of the one or more clusters in the first workload region based on the size of the workload.

4. The method of claim 3, wherein the size is based on a degree of parallelism of the workload.

5. The method of claim 1, wherein the workload includes a query.

6. The method of claim 5, further comprising:
compiling the query to generate an execution plan.

7. The method of claim 6, further comprising:
optimizing the execution plan based on a set of optimization rules; and
determining a size of the workload based on the optimized execution plan.

8. The method of claim 1, further comprising:
monitoring execution of the workload at a checkpoint; and
adjusting allocation of the virtual machines based on the monitoring.

9. A machine-storage medium embodying instructions that, when executed by a machine, cause the machine to perform operations comprising:
providing a plurality of warehouse endpoints in a network-based data warehouse system, each endpoint representing a different user-defined operation;
providing a plurality of workload regions in a compute layer, each workload region representing a workload type, each workload region including one or more clusters of virtual warehouses, and each endpoint being connected to each workload region;
receiving a workload;
routing the workload through a first warehouse endpoint of the plurality of warehouse endpoints to a first workload region of the plurality of workload regions; and
executing the workload by virtual machines in the first workload region.

10. The machine-storage medium of claim 9, further comprising:
identifying a type of the workload, wherein the workload is routed to the first workload region based on the type of the workload.

11. The machine-storage medium of claim 9, further comprising:
determining a size of the workload, wherein the workload is routed to a first cluster of the one or more clusters in the first workload region based on the size of the workload.

12. The machine-storage medium of claim 11, wherein the size is based on a degree of parallelism of the workload.

13. The machine-storage medium of claim 9, wherein the workload includes a query.

14. The machine-storage medium of claim 13, further comprising:
compiling the query to generate an execution plan.

15. The machine-storage medium of claim 14, further comprising:
optimizing the execution plan based on a set of optimization rules; and
determining a size of the workload based on the optimized execution plan.

16. The machine-storage medium of claim 9, further comprising:
monitoring execution of the workload at a checkpoint; and
adjusting allocation of the virtual machines based on the monitoring.

17. A system comprising:
at least one hardware processor; and
at least one memory storing instructions that, when executed by the at least one hardware processor, cause the at least one hardware processor to perform operations comprising:
providing a plurality of warehouse endpoints in a network-based data warehouse system, each endpoint representing a different user-defined operation;
providing a plurality of workload regions in a compute layer, each workload region representing a workload type, each workload region including one or more clusters of virtual warehouses, and each endpoint being connected to each workload region;
receiving a workload;
routing the workload through a first warehouse endpoint of the plurality of warehouse endpoints to a first workload region of the plurality of workload regions; and
executing the workload by virtual machines in the first workload region.

18. The system of claim 17, the operations further comprising:
identifying a type of the workload, wherein the workload is routed to the first workload region based on the type of the workload.

19. The system of claim 17, the operations further comprising:
determining a size of the workload, wherein the workload is routed to a first cluster of the one or more clusters in the first workload region based on the size of the workload.

20. The system of claim 19, wherein the size is based on a degree of parallelism of the workload.

21. The system of claim 17, wherein the workload includes a query.

22. The system of claim 21, the operations further comprising:
compiling the query to generate an execution plan.

23. The system of claim 22, the operations further comprising:
optimizing the execution plan based on a set of optimization rules; and
determining a size of the workload based on the optimized execution plan.

24. The system of claim 17, the operations further comprising:
monitoring execution of the workload at a checkpoint; and
adjusting allocation of the virtual machines based on the monitoring.
